(19) United States
(12) Patent Application Publication
(10) Pub. No.: US 2020/0193343 A1
(43) Pub. Date: Jun. 18, 2020

(54) DATA INTEGRATION APPARATUS AND DATA INTEGRATION METHOD

(71) Applicant: HITACHI, LTD., Tokyo (JP)

(72) Inventors: Takeshi HANDA, Tokyo (JP); Yuko YAMASHITA, Tokyo (JP); Hidenori YAMAMOTO, Tokyo (JP); Kenji KAWASAKI, Tokyo (JP); Syuuichirou SAKIKAWA, Tokyo (JP); Takashi TSUNO, Tokyo (JP)

(21) Appl. No.: 16/330,397

(22) PCT Filed: Mar. 21, 2017
(86) PCT No.: PCT/JP2017/011163

§ 371 Date: Mar. 5, 2019

(30) Foreign Application Priority Data
Oct. 7, 2016 (JP) 2016-198655

(51) Int. Cl. G06Q 10/06; G06F 7/48

(52) U.S. Cl. CPC G06Q 10/06311; G06F 7/48

(57) ABSTRACT

To support realization of efficient data conversion processing even between data with undefined conversion definition and the like. A data integration apparatus includes an arithmetic unit that calculates a similarity between a data format of a table regarding predetermined data, data format information of which has not stored in a storage device, and a master data format of each predetermined table, specifies a predetermined table in the master data format having the similarity that satisfies a predetermined criterion, calculates a similarity between the master data format of the specified predetermined table and a data format of each table of each system, specifies a predetermined table of a predetermined system having the similarity that satisfies a predetermined criterion, and outputs conversion processing definition information on the specified predetermined table in the master data format and the specified predetermined table of the predetermined system as reusable conversion processing component candidate information.

### TECHNICAL FIELD

The present invention relates to a data integration apparatus and a data integration method, and specifically relates to a technology for supporting realization of efficient data conversion processing even between data with undefined conversion definition and the like.

### BACKGROUND ART

Data integration apparatuses have been developed with the aim of promoting cross-sectional utilization of data across a variety of systems. Such a data integration apparatus collectively collects and accumulates a variety of data of various business systems as data sources while converting formats and structures of the accumulated data according to a request of a user.

In the above-described conversion processing, processing of associating mutual data items between a data structure of a conversion source data and a data structure of a conversion destination data is necessary in advance. In a case where the data to be processed is RDB data, a logic of such processing needs to be designed for each table.

In a case where data of a variety of systems are to be processed in the conversion processing, it is assumed that an enormous number of tables are to be converted. In that case, the time and effort required for associating the data items of tables also increase, and an increase in the number of work man-hours and costs of a design developer required for the logic design of the above-described conversion processing is concerned.

As a conventional technology for reducing the number of work man-hours of a designer accompanying such data integration, the following technology has been proposed. That is, proposed are an information integration device that executes an information integration program for converting data extracted from an information source and registering the data in a storage destination, the information integration program for causing a computer to execute: a step of comparing first schema information obtained from the information source with second schema information obtained from the information source before change of the first schema information, and detecting change of a schema of the information source; a step of searching a correspondence table storage unit that stores an attribute value included in schema information and item information in a data model in association with each other with an attribute value of an item relevant to the change of a schema; a step of repairing a data model before change that is a data model corresponding to the second schema information and stored in a meta information storage unit that stores the data model before change, using the item information corresponding to the attribute value of an item relevant to the change of a schema, to generate a data model after change, and storing the data model after change in a storage device, in a case where the attribute value of an item relevant to the change of a schema has been detected in the correspondence table storage unit; and a step of generating an after-change integration logic for converting the data model after change stored in the storage device into a data model corresponding to the storage destination, and storing the after-change integration logic in the meta information storage unit (see PTL 1), and the like.

### CITATION LIST

### Patent Literature

PTL 1: JP 2012-27690 A

### SUMMARY OF INVENTION

### Technical Problem

However, in the conventional technology, there are some cases where the data format necessary for a predetermined system or application requesting the above conversion processing is different from an integrated data format. Here, the integrated data format is, for example, a data format consisting of data items most commonly used among predetermined data in a variety of systems, and in which association of the data items has already defined among the data in the systems. Therefore, the data format required by the above-described predetermined system being different from the integrated data format means that definitions and the like necessary for the above-described conversion processing are in an unknown state.

In this case, design and development work of the conversion processing logic for converting the integrated data format into a data format required by the predetermined system or the like occurs. Further, in a case where data excluded from conversion (because the data is not commonly used among data in the systems) is requested in the above integrated data format, design of a correspondence table and a conversion processing logic for the above integration regarding predetermined data of an information source system is required in the data integration apparatus.

Therefore, an object of the present invention is to provide a technology for supporting realization of efficient data conversion processing even between data with undefined conversion definition and the like.

### Solution to Problem

A data integration apparatus of the present invention that solves the above problem includes a storage device configured to store information of a data format of each table used in a predetermined system in relation to data of a predetermined event and information of a master data format predetermined for each predetermined table as a universal data format among the data, and conversion processing definition information of data between the predetermined table in the master data format and a predetermined table in a predetermined data format of the predetermined system, and an arithmetic unit configured to execute processing of calculating a first similarity that is a similarity between a data format of a table regarding predetermined data, information of the data format of which has not been stored in the storage device, and the master data format of each predetermined table, and specifying a predetermined table in the master data format having the first similarity that satisfies a predetermined criterion, processing of calculating a second similarity that is a similarity between the master data format of the specified predetermined table and the data format of each table of the system stored in the storage device, and specifying a predetermined table of a predetermined system having the second similarity that satisfies a predetermined criterion, and processing of reading, from the storage device, the conversion processing definition information on the specified predetermined table in the master data format and the specified predetermined table of the predetermined system, and outputting the conversion processing definition information to a predetermined device as reusable conversion processing component candidate information.

Further, in a data integration method of the present invention, an information processing apparatus including a storage device that stores information of a data format of each table used in a predetermined system in relation to data of a predetermined event and information of a master data format predetermined for each predetermined table as a universal data format among the data, and conversion processing definition information of data between the predetermined table in the master data format and a predetermined table in a predetermined data format of the predetermined system, executes processing of calculating a first similarity that is a similarity between a data format of a table regarding predetermined data, information of the data format of which has not been stored in the storage device, and the master data format of each predetermined table, and specifying a predetermined table in the master data format having the first similarity that satisfies a predetermined criterion, processing of calculating a second similarity that is a similarity between the master data format of the specified predetermined table and the data format of each table of the system stored in the storage device, and specifying a predetermined table of a predetermined system having the second similarity that satisfies a predetermined criterion, and processing of reading, from the storage device, the conversion processing definition information on the specified predetermined table in the master data format and the specified predetermined table of the predetermined system, and outputting the conversion processing definition information to a predetermined device as reusable conversion processing component candidate information.

### Advantageous Effects of Invention

According to the present invention, realization of efficient data conversion processing can be supported even between data with undefined conversion definition and the like.

### BRIEF DESCRIPTION OF DRAWINGS

FIG. 1 is a diagram illustrating a network configuration example including a data integration apparatus in the present embodiment.

FIG. 2 is a diagram illustrating a data format example of a data structure definition table according to the present embodiment.

FIG. 3 is a diagram illustrating a data format example of a reusable component extraction result storage table according to the present embodiment.

FIG. 4 is a diagram illustrating a data format example of a similarity calculation parameter table according to the present embodiment.

FIG. 5 is a diagram illustrating an example of a data format for storing a result of calculating a similarity between a table in a master data format and a table in a data format requested by a distribution destination system according to the present embodiment.

FIG. 6 is a diagram illustrating an example of a data format for storing a result of calculating a similarity between a table in a master data format and a table in a data format defined in a data structure definition table according to the present embodiment.

FIG. 7 is a diagram illustrating a data format example of a data conversion processing component definition table according to the present embodiment.

FIG. 8 is a diagram illustrating a concept of data conversion/distribution processing in the data integration apparatus according to the present embodiment.

FIG. 9 is a diagram illustrating a hardware configuration example of the data integration apparatus in the present embodiment.

FIG. 10 is a diagram illustrating a flow example 1 of a data integration method in the present embodiment.

FIG. 11 is a diagram illustrating a data format example of a data structure of the data format requested by the distribution destination system according to the present embodiment.

FIG. 12a is a diagram illustrating a flow example 2 of the data integration method in the present embodiment.

FIG. 12b is a diagram illustrating a flow example 3 of the data integration method in the present embodiment.

FIG. 13 is a diagram for describing similarity calculation processing of a similarity between the data structure of the data format requested by the distribution destination system of the present embodiment and a data structure of the master data format.

FIG. 14 is a diagram illustrating a flow example 4 of the data integration method in the present embodiment.

FIG. 15a is a diagram (No. 1) for describing processing of extracting a reusable data conversion processing component candidate for data conversion into the data format requested by the distribution destination system according to the present embodiment.

FIG. 15b is a diagram (No. 2) for describing processing of extracting a reusable data conversion processing component candidate for data conversion into the data format requested by the distribution destination system according to the present embodiment.

FIG. 16 is a diagram illustrating a screen example 1 in the present embodiment.

FIG. 17 is a diagram illustrating a screen example 2 in the present embodiment.

### DETAILED DESCRIPTION OF EMBODIMENTS

### Network Configuration

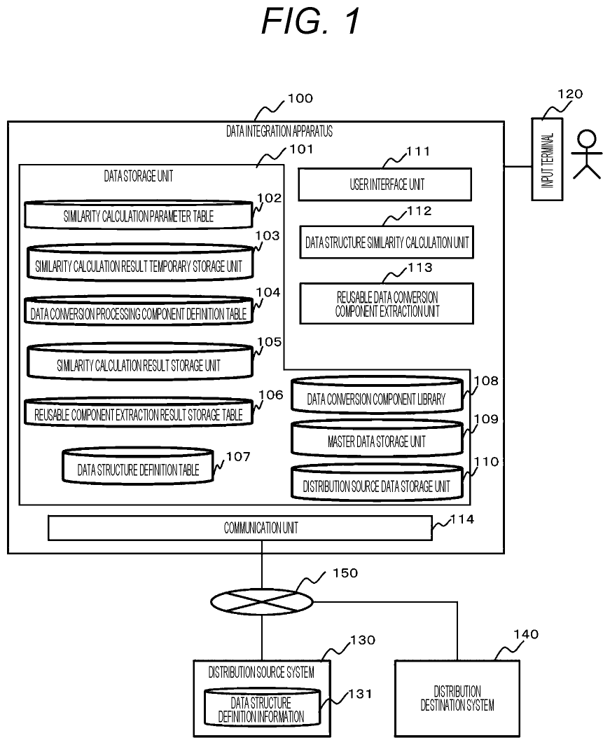

Hereinafter, an embodiment of the present invention will be described in detail with reference to the drawings. FIG. 1 is a diagram illustrating a network configuration example including a data integration apparatus 100 according to the present embodiment. As illustrated in FIG. 1, the data integration apparatus 100 according to the present embodiment is communicatively connected to an input terminal 120, a distribution source system 130, and a distribution destination system 140 via a dedicated line 150.

Among the aforementioned terminal and systems, the distribution source system 130 is a system that holds train diagram data managed and operated by, for example, a railway operator. Data distributed from the distribution source system 130 to the data integration apparatus 100 is converted into a data format in the distribution destination system 140 by a predetermined data conversion program (conversion processing definition) in the data integration apparatus 100 and is distributed to the distribution destination system 140.

Further, the distribution destination system 140 is a system managed and operated by a railway operator who executes appropriate businesses and services on the basis of predetermined data derived from the above-described distribution source system 130. Specifically, a system or the like that operates and manages trains using observation data of a train operation state and the above-described train diagram data can be assumed.

Further, the input terminal 120 is a terminal operated by a design developer of a data conversion program for converting data obtained from the distribution source system 130 into a data format desired by the distribution destination system 140.

The data integration apparatus 100 according to the present embodiment included in such a network configuration includes, as functional components implemented by appropriate hardware and software, a user interface unit 111, a data structure similarity calculation unit 112, a reusable data conversion component extraction unit 113, and a communication unit 114. Further, the data integration apparatus 100 includes a data storage unit 101 as a storage destination of data handled by such functional units.

Among the above-described functional units, the data structure similarity calculation unit 112 calculates a similarity between a data structure in a table in a data format requested by the distribution destination system 140 and a data structure in a table in a master data format held by the data integration apparatus 100 in advance. As the above-described master data format (integrated data format), a data format of a predetermined table consisting of data items commonly used across a plurality of the distribution destination systems 140 regarding data of a predetermined business is assumed, for example.

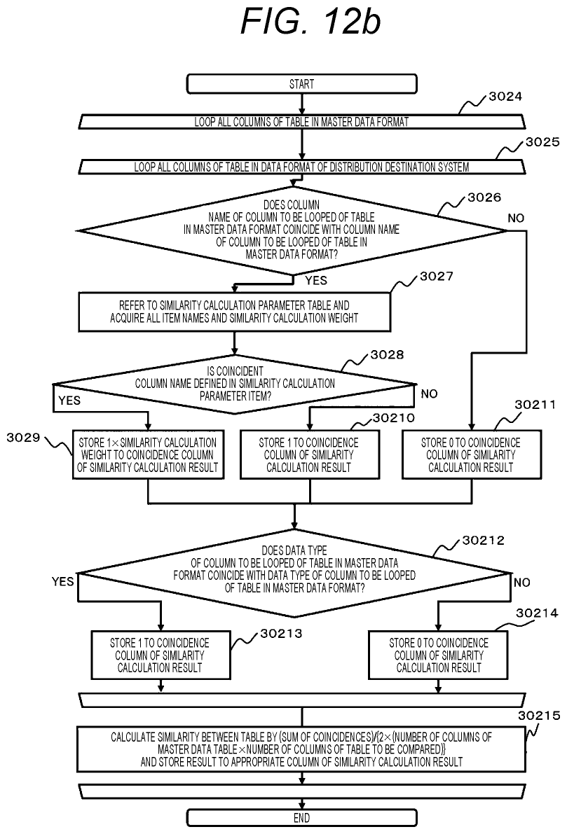

Note that, assume that, in the relationship between the master data format and the data format in the distribution destination system 140 (the data format already known by the data integration apparatus 100), the correspondence between data items has already defined, that is, the data conversion program for performing data conversion processing between data items of an appropriate table has already stored in the data integration apparatus 100. Details of a processing procedure performed by the data structure similarity calculation unit 112 will be described below with reference to the flowchart illustrated in FIG. 12a.

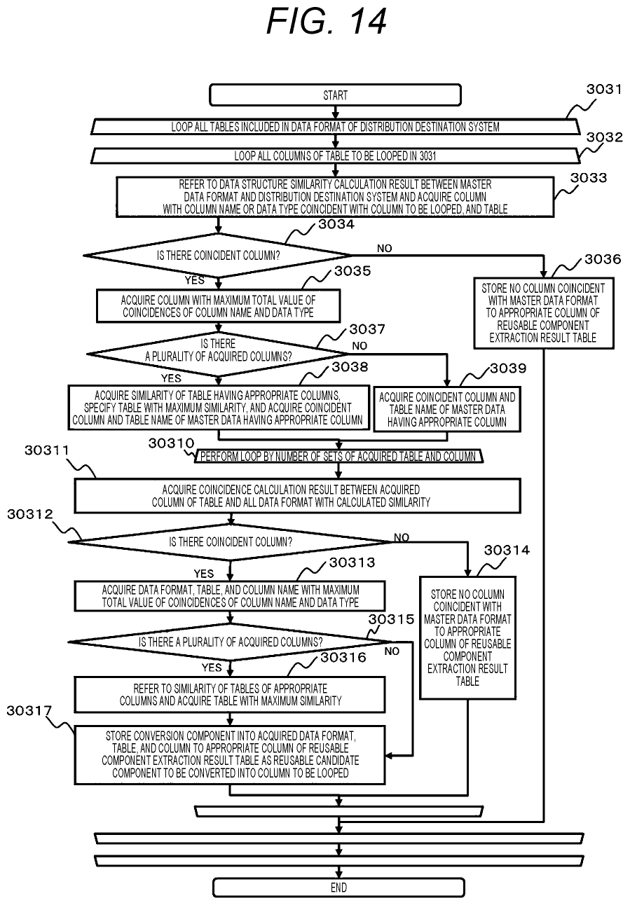

Further, the reusable data conversion component extraction unit 113 extracts a candidate of the data conversion program, that is, “reusable data conversion processing component candidate”, the data conversion program converting data distributed from the distribution source system 130 into the data format requested by the distribution destination system 140 via the master data format. Details of a processing procedure performed by the reusable data conversion component extraction unit 113 will be described below with reference to the flowchart illustrated in FIG. 14.

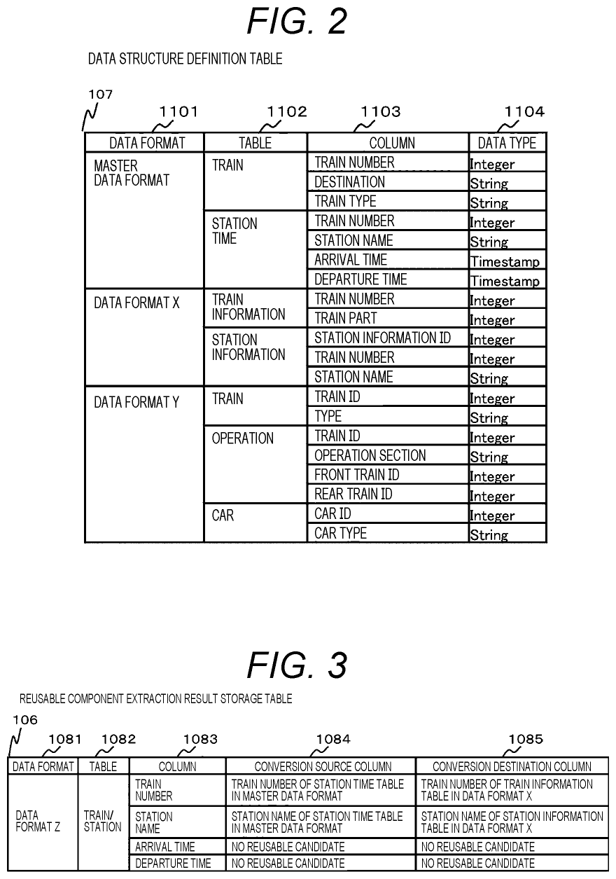

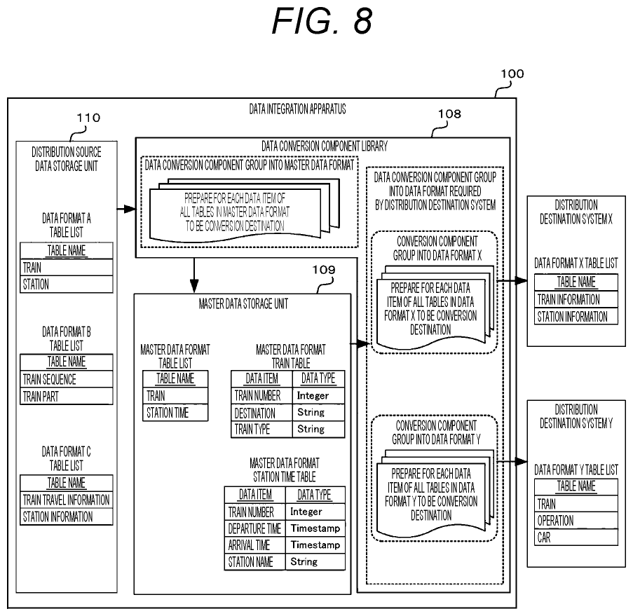

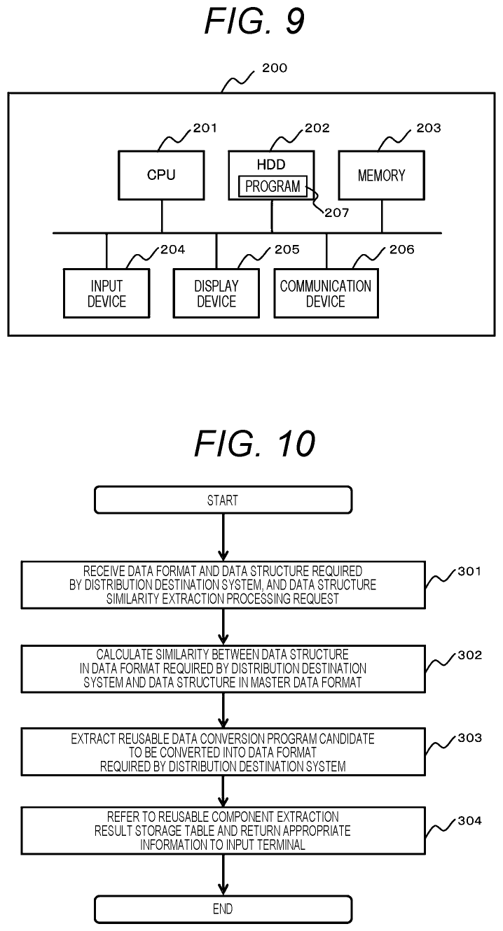

Further, the communication unit 114 communicates with the distribution source system 130 via the dedicated line 150, and transmits and receives the predetermined distribution data and data structure definition information 131 related to the distribution data. As the above-described distribution data (for example, the train diagram data), tabular data having a data structure defined in a data structure definition table 107 (FIG. 2) is assumed. The data integration apparatus 100 obtains such tabular data from the distribution source system 130 and stores the tabular data in a distribution source data storage unit 110 (FIG. 8).

Meanwhile, the above-described data structure definition information 131 is information configured by information of a data format of the distribution data, a table name, a column in the table, and a data type of the column. The data integration apparatus 100 stores the data structure definition information 131 in the data structure definition table 107.

The above-described data structure definition table 107 has the data format illustrated in FIG. 2, and includes, as data items, a data format 1101, a table 1072, a column 1103, and a data type 1104. In the example illustrated in FIG. 2, information of structure definition related to total of three kinds of data formats: “master data”, “data format X”, and “data format Y” is stored.

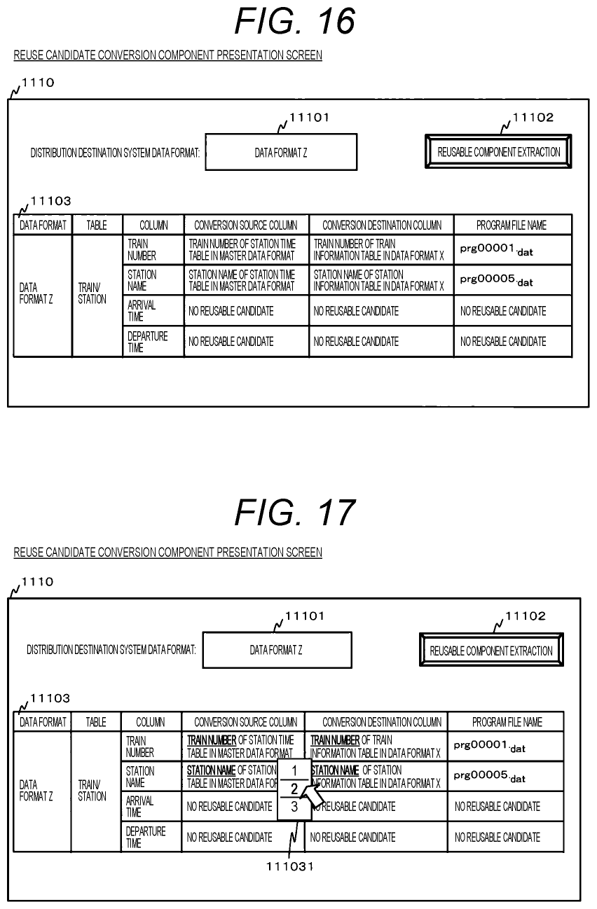

Next, the user interface unit 111 generates a reusable candidate conversion component presentation screen 1110 (FIG. 16) presenting, to the design developer of the data conversion program, candidates of the usable data conversion program (data conversion components) for performing data conversion processing into the data format of the distribution destination system 140.

The reusable candidate conversion component presentation screen 1110 is configured by a distribution destination system data format input area 11101 for inputting the data format of the distribution destination system 140, a reusable component extraction button 11102, and a reusable candidate conversion component list display area 11103.

Assume that the design developer of the data conversion program browses the reusable candidate conversion component presentation screen 1110 with the input terminal 120, and inputs the data format required in the distribution destination system 140 to the distribution destination system data format input area 11101 and presses the reusable component extraction button 11102. In this case, the data integration apparatus 100 executes data structure similarity calculation processing and reusable data conversion component extraction processing according to the data format input in the distribution destination system data format input area 11101.

Note that reuse candidate conversion components (known data conversion programs) read from a reusable component extraction result storage table 106 (FIG. 3) by the data integration apparatus 100 are displayed as a list in the reusable candidate conversion component list display area 11103.

The reusable component extraction result storage table 106 has the data format illustrated in FIG. 3 and includes, as data items, a data format 1081, a table 1062, and a column 1083 in the distribution destination system 140, a conversion source column 1084 indicating appropriate table and column in the master data format, which are references of data conversion, and a conversion destination column 1085 (known by the data conversion program for associating a value of a predetermined column of a predetermined table in the master data format with a value of a predetermined column of a predetermined table in a data format in a predetermined distribution destination system, that is, for performing data conversion processing).

In the example illustrated in FIG. 3, as for a column “train number” of a data table “train/station” of distribution destination data “data format Z”, a data conversion program for converting “a train number column of a station time table in the master data format” into “a train number column of a train information table in the data format X” is a reusable candidate, and appropriate information of the reusable candidate is stored.

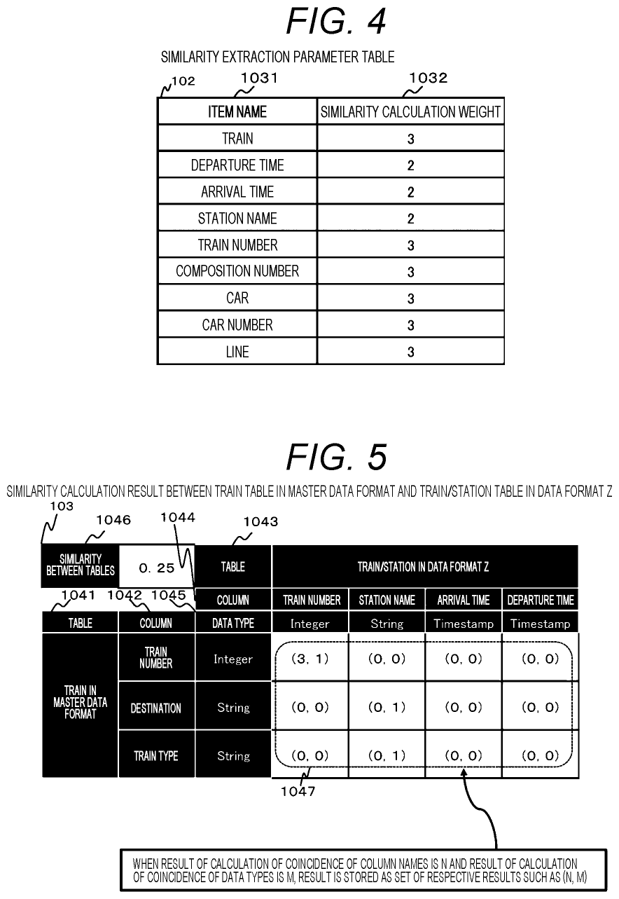

Further, a similarity calculation parameter table 102 in the data storage unit 101 has the data format illustrated in FIG. 4, and defines information of a weight value used in the data structure similarity calculation processing. As data items, an item name 1031 and a similarity calculation weight 1032 are included.

Among the data items, the item name 1031 indicates a column name in the table and stores values of “train” and “departure time” in the example of FIG. 4. Further, the similarity calculation weight 1032 indicates a weight value to be applied to a result of coincidence determination of an appropriate column in similarity calculation between data structures, and stores values of “2” and “3” as the similarity calculation weights in the example of FIG. 4. These data in the similarity calculation parameter table 102 are registered in advance by an expert.

Further, a similarity calculation result temporary storage unit 103 in the data storage unit 101 serves as a storage destination in which a result of calculation of the similarity between the table in the master data format and the table in the data format requested by the distribution destination system 140 in a tabular format, as illustrated in FIG. 5.

As data items, a table 1041, a column 1042, a table 1043, a column 1044, a data type 1045, and a similarity between tables 1046 are included.

Among the data items, the table 1041 indicates a table name in the master data format, and the column 1042 indicates a column name of a table stored in the table 1041. Further, the table 1043 indicates a table name in the data format requested by the distribution destination system 140, and the column 1044 indicates a column name of a table stored in the table 1043.

Further, the data type 1045 indicates data types of the above-described columns 1042 and 1044. Further, the similarity between tables 1046 indicates a calculation result of the similarity between the tables stored in the above-described tables 1041 and 1043. Note that a calculation result regarding a coincidence between columns is stored in a coincidence storage area 1047.

Here, when a result of calculation of a coincidence between names of columns is N and a result of calculation of a coincidence between data types is M, the results are stored as a set of the coincidence calculation results in a manner of (N, M).

Note that the length in a vertical direction in the table illustrated in FIG. 5 corresponds to the number of columns of the table stored in the table 1041, and the length in a horizontal direction in the table corresponds to the number of columns of the table stored in the table 1043.

Further, the example of FIG. 5 illustrates a result of calculation of the similarity between a “train” table in the master data format and a “train/station” table in the “data format Z”. Since both a “train number” column of the “train” table in the master data format and a “train number” column in the “train/station” table in the “data format Z” have the column name “train number”, the coincidence of the column name is calculated as 1×the similarity calculation weight (3)=3. Further, since both the columns have a data type “Integer (integer type)”, the coincidence of the data type is 1.

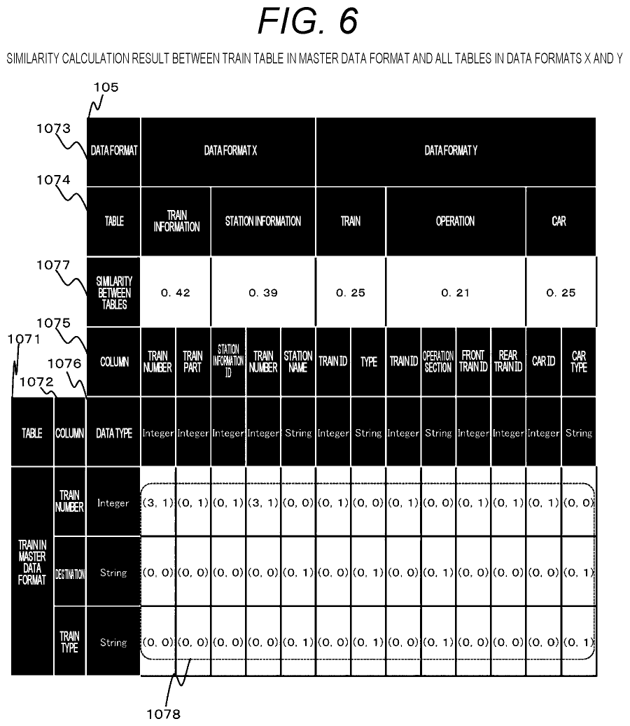

Further, a similarity calculation result storage unit 105 in the data storage unit 101 stores a result of calculation of the similarity between the table in the master data format and the table in the data format defined in the data structure definition table in a tabular format illustrated in FIG. 6. As data items, a table 1071, a column 1072, a data format 1073, a table 1074, a column 1075, a data type 1076, and a similarity between tables 1077.

Among the data items, the table 1071, the column 1072, the table 1074, the column 1075, the data type 1076, and the similarity between tables 1077 have similar configurations to the data format example of the similarity calculation result temporary storage unit 103 illustrated in FIG. 5 above. Further, the data format 1073 has a similar configuration to the data item of the data format of the data structure definition table 107. A value stored in a coincidence storage area 1078 has a similar configuration to the data format example of the similarity calculation result temporary storage unit 103 illustrated in FIG. 5 above. The example of FIG. 6 illustrates a result of calculation of the similarity between the “train” table in the master data format and each of all tables in the “data format X” and the “data format Y”.

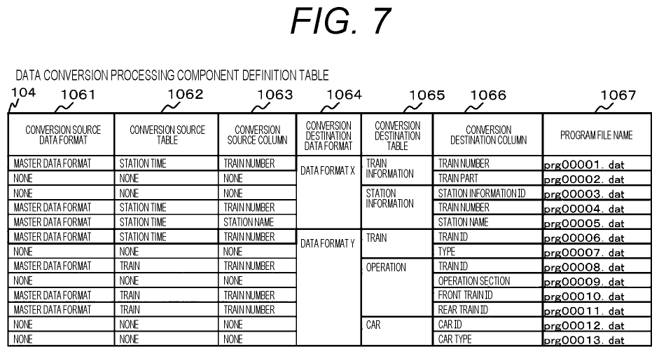

Further, a data conversion processing component definition table 104 in the data storage unit 101 is a data table that defines information of the data conversion program for converting a data format, and has the data format illustrated in FIG. 7.

As data items, a conversion source data format 1061, a conversion source table 1042, a conversion source column 1063, a conversion destination data format 1064, a conversion destination table 1065, a conversion destination column 1066, and a program file name 1067 are included.

Among the data items, the conversion source data format 1061 indicates a data format of conversion source data, the conversion source table 1042 indicates a data table name of the conversion source data, and the conversion source column 1063 indicates a column name of a conversion source data table.

Further, the conversion destination data format 1064 indicates a data format of the conversion destination data, the conversion destination table 1045 indicates a data table name of the conversion destination data, the conversion destination column 1066 indicates a column name of a conversion destination data table, and the program file name 1067 indicates a file name of a program for converting data from the conversion source column 1063 into the conversion destination column 1066.

In the example of the data conversion processing component definition table 104 illustrated in FIG. 7, a name of a program “prg00001.dat” for converting a column “train number” of a table “station time” in the master data format into a column “train number” of a table “train information” in the “data format X” is stored.

Concept of Data Conversion Processing Here, the concept of the principle of the data conversion processing in the data integration apparatus 100 according to the present embodiment will be described. FIG. 8 is an explanatory diagram illustrating the principle of the data conversion processing in the data integration apparatus 100.

The data integration apparatus 100 in the present embodiment converts distribution source data stored in the distribution source data storage unit 110 into the master data format and stores the converted data in a master data storage unit 109. Further, the data integration apparatus 100 converts the above-described data stored in the master data storage unit 109 into the data format requested by the distribution destination system 140. In the data format conversion processing, the data integration apparatus 100 associates a column in a table on the conversion source with a column in a table on the conversion destination, performs type conversion and arithmetic operation, and stores a result to a data conversion component library 108 as the data conversion program. In the example illustrated in FIG. 8, conversion of the data in the master data format stored in the master data storage unit 109 into the “data format X” requested by a “distribution destination system X” is realized using the data conversion program for each of all columns of all tables in the “data format X”, of a data conversion component group (data conversion program group) for data conversion into the data format requested by the distribution destination system 140 in the data conversion component library 108. Assume that the data conversion program for data conversion into the data format requested by the distribution destination system 140 is developed in advance and registered in the data conversion component library 108.

Details of the processing by these functional units will be described below with reference to the flowcharts illustrated in FIGS. 10, 12a, 12b, and 14.

### Hardware Configuration

A hardware configuration of the data integration apparatus 100 in the present embodiment is as follows. FIG. is a diagram illustrating a hardware configuration example of the data integration apparatus 100.

The data integration apparatus 100 according to the present embodiment includes a CPU 201, an HDD 202, a memory 203, an input device 204, a display device 205, and a communication device 206. Among the devices, the CPU 201 is an arithmetic unit that inputs, outputs, reads, and stores data, and executes various types of processing. Further, the HDD 202 is nonvolatile storage means for storing data. Further, the memory 203 is volatile storage means for temporarily storing a program and data.

Further, the input device 204 is a device such as a keyboard, a mouse, or a microphone that accepts an operation input from a user. Further, the display device 205 is a device such as a display that displays data to the user. Further, the communication device 206 is a device such as a network card that communicates with the distribution source system 130 and the distribution destination system 140 via the dedicated line 150 and transmits and receives data.

In such a data integration apparatus 100, the CPU 201 executes, for example, a program 207 stored in the HDD 202 or the memory 203 to implement the above-described functional units.

### Main Flow Example

Hereinafter, an actual procedure of a data integration method in the present embodiment will be described with reference to the drawings. Various operations corresponding to the data integration method described below are realized by a program read by the data integration apparatus 100 into the memory or the like and executed by the data integration apparatus 100. Then, this program configured by codes for performing the various operations to be described below.

FIG. 10 is a diagram illustrating a flow example 1 of the data integration method in the present embodiment, and is specifically a flowchart illustrating a series of procedures of calculating the data structure similarity in the data integration apparatus 100, and extracting a reusable data conversion program from existing data conversion programs (in order to convert the data of the distribution source system 130 into the data format desired by the distribution destination system 140).

Here, assume that the design developer of the data conversion program inputs the data format requested by the distribution destination system 140, a data structure, and a data structure similarity calculation processing request on a design developer presentation screen 1110 in FIG. 16 displayed on the input terminal 120.

In this case, the data integration apparatus 100 receives information of the data format requested by the distribution destination system 140 and the data structure, and the data structure similarity calculation processing request, which have been input by the design developer of the data conversion program, from the input terminal 120 (301). Of course, this step is unnecessary in a case where the data integration apparatus 100 has previously obtained such information through another means and route.

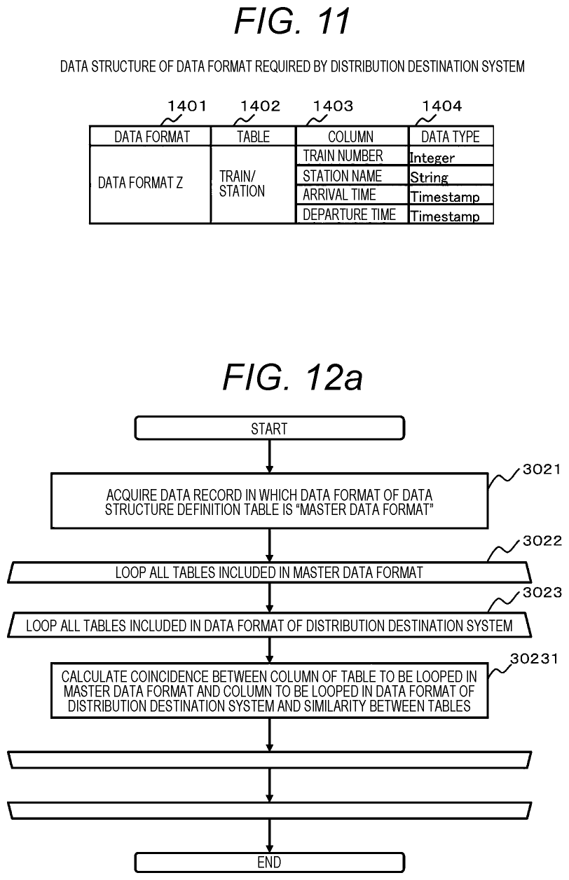

FIG. 11 illustrates a data format example indicating a data structure related to the “train/station” table in the data format “data format Z” requested by the distribution destination system 140. The data items in the illustrated data structure include a data format 1401, a table 1402, a column 1403, and a data type 1404. The configuration of the data items is similar to the configuration of the data items of the above-described data structure definition table 107.

Next, the data structure similarity calculation unit 112 of the data integration apparatus 100 calculates the similarity between the data structure in the table in the data format requested by the distribution destination system 140 and the data structure in each table in the master data format (302).

Further, the reusable data conversion component extraction unit 113 of the data integration apparatus 100 extracts candidates of the reusable data conversion processing program for performing data conversion into the data format requested by the distribution destination system 140 (303).

Next, the user interface unit 111 of the data integration apparatus 100 refers to the reusable component extraction result storage table 106 illustrated in FIG. 3, generates a screen displaying a list of reusable programs as the data conversion programs for performing data conversion into the data format requested by the distribution destination system 140, returns the screen (FIG. 16) (304), and terminates the processing.

Note that details of a processing procedure performed by the data structure similarity calculation unit 112 will be described below with reference to the flowchart illustrated in FIG. 12a. Further, details of a processing procedure performed by the reusable data conversion component extraction unit 113 will be described below with reference to the flowchart illustrated in FIG. 14.

### Detailed Flow Example 1

FIG. 12a is a flowchart illustrating details of a procedure in which the data structure similarity calculation unit 112 calculates the similarity between the data structure in the table in the data format requested by the distribution destination system 140 and the data structure in each table in the master data format.

First, the data structure similarity calculation unit 112 of the data integration apparatus 100 acquires a data record of each table having the data format of “master data format” in the data structure definition table 107 (3021).

Next, the data structure similarity calculation unit 112 of the data integration apparatus 100 loops all the tables in the master data format, the data records of which have been acquired in step 3021 (3022).

Next, the data structure similarity calculation unit 112 of the data integration apparatus 100 loops all tables in data formats other than the “master data format” and registered in the data structure definition table 107, that is, all tables in known data formats of the distribution destination system 140 (3023).

Next, the data structure similarity calculation unit 112 of the data integration apparatus 100 calculates a coincidence between a column of a table to be looped, which is the table in the master data format obtained in step 3021, and a column of a table to be looped, which is the table in the data format of the distribution destination system 140 and is the table to be looped in step 3023, and the similarity between the tables (30231). Details of the processing procedure of calculating the similarity between the tables will be described with the flowchart illustrated in FIG. 12b.

FIG. 12b is a flowchart illustrating details of a procedure in which the data structure similarity calculation unit 112 calculates the coincidence between the column of the table to be looped in the master data format and the column of the table to be looped in the data format of the distribution destination system 140, and the similarity between the tables.

In this flow, first, the data structure similarity calculation unit 112 of the data integration apparatus 100 loops all columns of the table in the master data format, the table having been looped in step 3022 (3024).

The data structure similarity calculation unit 112 of the data integration apparatus 100 loops all columns of the table in the data format of the distribution destination system 140, the table having been looped in step 3023 (3025).

Next, the data structure similarity calculation unit 112 of the data integration apparatus 100 determines whether the column name of the column to be looped in the table to be looped in the master data format coincides with the column name of the column to be looped of the table to be looped in the data format of the distribution destination system 140 (3026).

As a result of the above-described determination, when both the column names do not coincide (3026: NO), the data structure similarity calculation unit 112 of the data integration apparatus 100 stores “0” in the coincidence storage area 1047 of the similarity calculation result temporary storage unit 103 (30211).

On the other hand, as a result of the above-described determination, when both the column names coincide (3026: YES), the data structure similarity calculation unit 112 of the data integration apparatus 100 refers to the similarity calculation parameter table 102 and obtains values of all the item names in the table and similarity calculation weights (3027).

The data structure similarity calculation unit 112 of the data integration apparatus 100 determines whether the target column name with the “coincident” determination result in step 3026 is defined in the item names obtained in step 3027 (3028).

As a result of the above-described determination, when the target column name is not defined (3028: NO), the data structure similarity calculation unit 112 of the data integration apparatus 100 stores “1” in the coincidence storage area 1047 of the similarity calculation result temporary storage unit 103 (30210).

On the other hand, as a result of the above-described determination, when the target column name is defined (3028: YES), the data structure similarity calculation unit 112 of the data integration apparatus 100 stores the calculation result of “1×the similarity calculation weight” in the coincidence storage area 1047 of the similarity calculation result temporary storage unit 103 (3029).

Next, the data structure similarity calculation unit 112 of the data integration apparatus 100 determines whether the data type of the column to be looped in the table to be looped in the master data format with the data type of the column to be looped of the table to be looped in the data format of the distribution destination system 140 (30212).

As a result of the above-described determination, when both the data types coincide (30212: YES), the data structure similarity calculation unit 112 of the data integration apparatus 100 stores “1” in the coincidence storage area 1047 of the similarity calculation result temporary storage unit 103 (30213).

On the other hand, as a result of the above-described determination, when both the data types do not coincide (30212: NO), the data structure similarity calculation unit 112 of the data integration apparatus 100 stores “0” in the coincidence storage area 1047 of the similarity calculation result temporary storage unit 103 (30214).

Next, the data structure similarity calculation unit 112 of the data integration apparatus 100 calculates the similarity between the table in the master data format and the table in the data format of the distribution destination system 140, the tables having been looped in the above description, by an expression of (a sum of coincidences)/{2×(the number of columns in the master data table×the number of columns of a table to be compared)}, stores a calculation result in the similarity between tables 1046 of the similarity calculation result temporary storage unit 103 (30215), and terminates the processing.

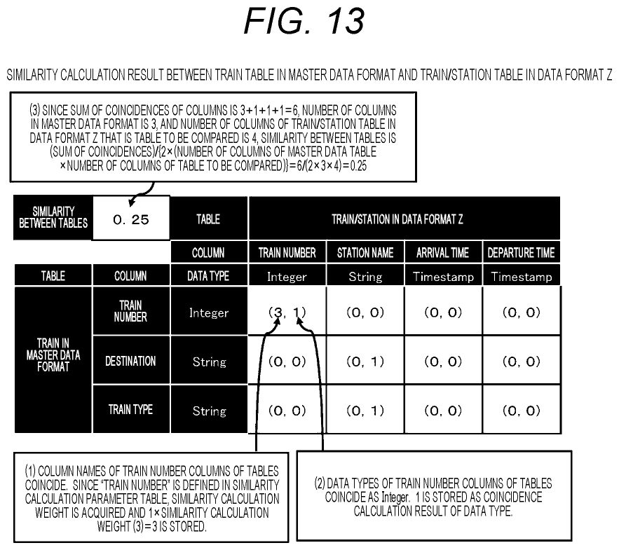

Here, a specific example of the processing illustrated in the flows in FIGS. 12a and 12b will be described on the basis of FIG. 13. FIG. 13 is an explanatory diagram illustrating the concept of the similarity calculation processing for the “train” table in the master data format and the “train/station” table in the “data format Z”.

In this case, the data integration apparatus 100 determines that the column names of the “train number” columns of the “train” table in the master data format and of the “train/station” table in the “data format Z” coincide. The coincident column name “train number” is defined in the item name of the similarity calculation parameter table 102. Therefore, the data integration apparatus 100 acquires the similarity calculation weight “3” corresponding to this “train number”.

Therefore, the data integration apparatus 100 stores “3” that is the coincidence calculation result of the column name in an area 10471 corresponding to the “train number” column in the coincidence storage area 1047.

Next, since both the data types of this “train number” column are “Integer” and coincide, the data integration apparatus 100 stores “1” in an area 10471 corresponding to the “train number” column in the coincidence storage area 1047 as the coincidence calculation result of the data type. The data integration apparatus 100 performs the above-described processing for all sets of each column of the “train” table in the master data format and each column of the “train/station” table in the “data format Z”.

Finally, the data integration apparatus 100 calculates the similarity between tables for the “train” table in the master data format and the “train/station” table in the “data format Z”. Here, the sum of coincidences of the columns stored in the coincidence storage area 1047 illustrated in FIG. 7 is 3+1+1+1=6, and the number of columns in the “train” table in the master data format is 3 and the number of columns in the “train/station” table in the “data format Z” is 4.

From the above, the data integration apparatus 100 calculates the similarity between the tables as (the sum of coincidences)/{2×(the number of columns in the master data table× the number of columns of a table to be compared)}=6/(2×3×4)=0.25

### Detailed Flow Example 2

FIG. 14 is a flowchart illustrating details of the procedure (step 303 in the main flow) in which the reusable data conversion component extraction unit 113 of the data integration apparatus 100 extracts a candidate of the data conversion processing program, which is reusable in converting predetermined data of the distribution source system 130 into the data format requested by the distribution destination system 140. Note that the “reusable data conversion program” is a defined, that is, known data conversion program in order to convert data in a predetermined table of the distribution source system 130 into a data format of a predetermined distribution destination system 140, in the relationship with a predetermined table in the master data format.

That is, the data integration apparatus 100 of the present embodiment provides information of the known data conversion program in order to reuse the information for the data format of the distribution destination system 140 for which the data conversion program has not been defined yet.

In this flow, the reusable data conversion component extraction unit 113 of the data integration apparatus 100 loops all appropriate tables (information of which has been obtained in step 301) in the data format requested by the distribution destination system 140 (3031).

Next, the reusable data conversion component extraction unit 113 of the data integration apparatus 100 loops all columns of the table to be looped within the loop (3032).

Here, regarding the relationship between each table in the master data format and the table to be looped in the data format of the distribution destination system 140, the reusable data conversion component extraction unit 113 of the data integration apparatus 100 refers to the similarity calculation result storage unit 105 (FIG. 6) and acquires information of a column in the master data format having a coincident column name or data type with the column of the table to be looped, and information of the table (3033).

Next, the reusable data conversion component extraction unit 113 of the data integration apparatus 100 determines whether there is a column with a coincident column name or data type, that is, a column with the coincidence of (a, b) (a>0 or b>0), as a result of step 3033 above (3034).

As a result of this determination, when there is no appropriate column (3034: NO), the reusable data conversion component extraction unit 113 of the data integration apparatus 100 stores a value of “no reusable candidate” in the conversion source column 1084 and the conversion destination column 1085 of the reusable component extraction result storage table 106 (3036).

On the other hand, as a result of the above determination, when there is the appropriate column (3034: YES), the reusable data conversion component extraction unit 113 of the data integration apparatus 100 specifies an appropriate column having a maximum total value of coincidences of the column name and the data type in the appropriate columns (3035).

Next, the reusable data conversion component extraction unit 113 of the data integration apparatus 100 determines whether there is a plurality of the columns specified in step 3035 above (3037).

As a result of the determination, in a case where there is not a plurality of the appropriate columns (3037: NO), that is, in a case where there is only one appropriate column, the reusable data conversion component extraction unit 113 of the data integration apparatus 100 acquires the column name of the appropriate column in the appropriate table in the master data format and the table name of the table in the master data format having the appropriate column (3039).

On the other hand, as a result of the above-described determination, in a case where there is a plurality of the appropriate columns (3037: YES), the reusable data conversion component extraction unit 113 acquires the similarity of each table having the appropriate column, and specifies the table in the master data format having the maximum similarity in tables (3038). Further, in step 3038, the reusable data conversion component extraction unit 113 of the data integration apparatus 100 acquires the column name of the appropriate column in the specified table in the master data format and an appropriate table name.

Next, the reusable data conversion component extraction unit 113 of the data integration apparatus 100 performs loop by the number of sets of the appropriate column and the appropriate table of which the column name and the table name have been acquired in either step 3038 or step 3039 (30310).

Here, the reusable data conversion component extraction unit 113 of the data integration apparatus 100 refers to the similarity calculation result storage unit 105, and acquires a coincidence calculation result of the column to be looped, regarding the table in the master data format targeted in the loop, and each table of all the data formats in the distribution destination system 140 for which the similarity with the table in the master data format have been calculated (30311).

The reusable data conversion component extraction unit 113 of the data integration apparatus 100 determines whether there is a column with the coincident column name or data type, that is, a column with the coincidence of (a, b) (a>0 or b>0) between the table in the master data format and any of the tables in all the data formats in the distribution destination system 140 (30312). As a result of the determination, when there is no appropriate column (30312: NO), the reusable data conversion component extraction unit 113 of the data integration apparatus 100 stores the value of “no reusable candidate” in the conversion source column 1084 and the conversion destination column 1085 of the reusable component extraction result table storage 106 (30314).

On the other hand, as a result of the determination, when there is the appropriate column (30312: YES), the reusable data conversion component extraction unit 113 of the data integration apparatus 100 acquires information of the data format, the appropriate table, and the column name of the distribution destination system 140 with the maximum total value of the coincidences of the column name and the data type of the appropriate column (30313).

Next, the reusable data conversion component extraction unit 113 of the data integration apparatus 100 determines whether there is a plurality of the columns acquired in step 30313 (30315).

As a result of the determination, when there is a plurality of the appropriate columns (30315: YES), the reusable data conversion component extraction unit 113 of the data integration apparatus 100 refers to the similarity between each table including the appropriate column and a corresponding table in the master data format, and specifies a table with the maximum similarity in the appropriate tables (30316).

On the other hand, when there is not a plurality of the appropriate columns (30315: NO), the reusable data conversion component extraction unit 113 of the data integration apparatus 100 advances the processing to step 30317.

Next, the reusable data conversion component extraction unit 113 of the data integration apparatus 100 determines that the data conversion program for converting the data of the column in the predetermined table in the master data format into the data of the column of the appropriate table in the data format (of the distribution destination system 140) specified in step 3016, as a reusable candidate component for performing conversion into the column of the table to be looped in step 3031 or step 3032, and stores the “column of the table in the master data format acquired in step 3038 or step 3039” in the conversion source column 1084 of the reusable component extraction result storage table 106 and stores the “acquired column of the table in the data format of the distribution destination system 140” in the conversion destination column 1085 (30317).

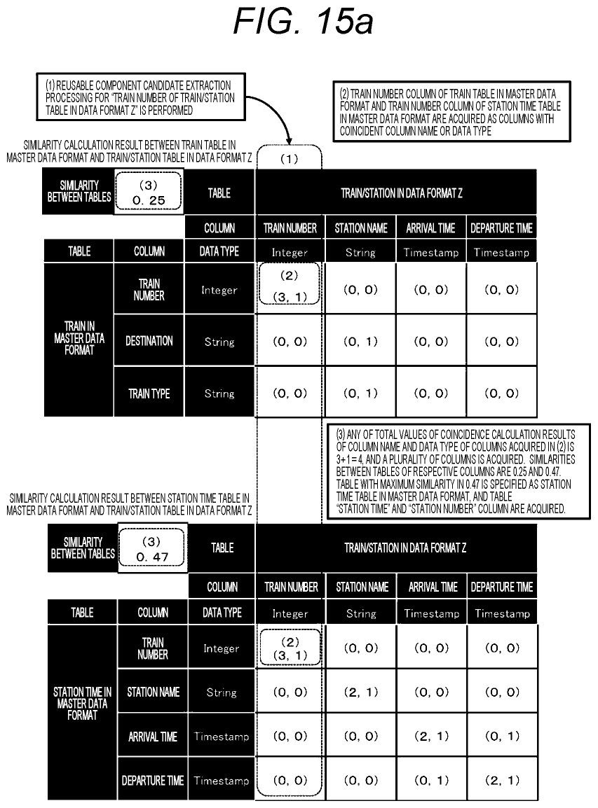

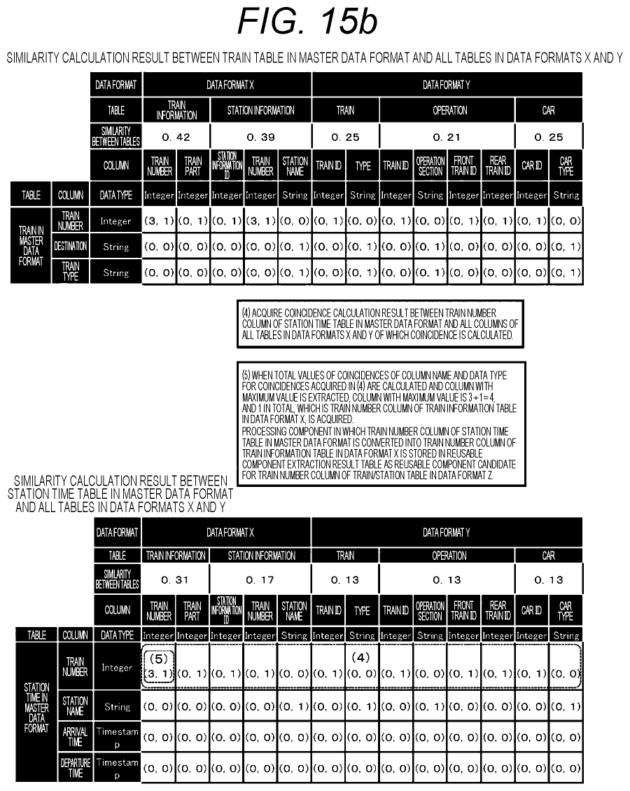

Here, FIGS. 15a and 15b illustrate a specific processing concept of extracting the reusable data conversion processing component candidate as the data conversion program for performing data conversion into the column “train number” of the “train/station” table in the data format “data format Z” requested by the distribution destination system 140.

First, as illustrated in FIG. 15a, processing of calculating the similarity between the “train” table in the master data format and the “train/station” table in the “data format Z” will be described. In this case, the reusable data conversion component extraction unit 113 of the data integration apparatus 100 acquires information of the “train number” column of the “train” table in the master data format and information of the “train number” column of the “station time” table in the master data format, as the columns having the coincident column name or data type between the tables.

Next, the reusable data conversion component extraction unit 113 of the data integration apparatus 100 calculates a total value of the coincidence calculation results of the column name and the data type of the above acquired column as 3+1=4 for each of the “train number” column of the “train” table in the master data format and the “train number” column of the “station time” table in the master data format. Therefore, the two columns having the same total value of the coincidences are specified.

The similarities between tables regarding the tables (the “train” table and the “station time” table) in the master data format having the two columns, and the “train/station” table in the “data format Z” are “0.25” and “0.47”, respectively.

Therefore, the reusable data conversion component extraction unit 113 of the data integration apparatus 100 specifies the “station time” table in the master data format, which has the maximum similarity between tables of “0.47”, and acquires the name of the “station time” table and the name of the “train number” column in the master data format.

Next, as illustrated in FIG. 15b, the reusable data conversion component extraction unit 113 of the data integration apparatus 100 acquires the coincidence calculation results between the “train number” column of the “station time” table in the master data format and all the columns of all the tables in the “data format X” and in the “data format Y” of which the similarities have been calculated.

Further, the reusable data conversion component extraction unit 113 of the data integration apparatus 100 calculates the total values of the coincidences of the column name and the data type, for the above acquired coincidence calculation results, and extracts a column with the maximum value. In this case, the maximum value is 3+1=4, which is specified as the “train number” column of the “train information” table in the “data format X”.

Therefore, the reusable data conversion component extraction unit 113 of the data integration apparatus 100 stores a processing component that converts the “train number” column of the “station time” table in the master data format into the “train number” column of the “train information” table in the “data format X” in the reusable component extraction result storage table 106 as a reusable component candidate for performing data conversion into the “train number” column of the “train/station” table in the “data format Z”.

### Screen Display Example

Next, an example of a screen generated by the user interface unit 111 of the data integration apparatus 100 and displayed on the input terminal 120 will be described. FIG. 16 is a diagram illustrating an example of a screen generated by the user interface unit 111 and illustrating the reusable candidate conversion component presentation screen 1110 presented to the design developer of the data conversion program via the input terminal 120.

The reusable candidate conversion component presentation screen 1110 configured by the distribution destination system data format input area 11101, the reusable component extraction button 11102, and the reuse candidate conversion component display area 11103.

Among the areas, in the reuse candidate conversion area 11103, information of records with the coincident data items in the distribution destination data format of the reusable component extraction result storage table 106, using the value input to the distribution destination system data format input area 11101 as a key, and file names of the data conversion programs for converting data from the conversion source column 1084 into the conversion destination column 1085, of the records, are displayed. Further, the file name of the data conversion program is a value of the program file name 1067 of the record extracted from the data conversion processing component definition table 104, using the values of the conversion source column 1084 and the conversion destination column 1085 of the above records as keys.

In the example illustrated in FIG. 16, a result of extraction of the reusable candidates of the data conversion programs for converting the data in the master data format are illustrated for “train number”, “station name”, “arrival time”, and “departure time”, which are the columns of the “train/station” table in the distribution destination data format “data format Z”.

Further, regarding the “train number” and “station name” columns in the above columns, a data conversion program “prg00001.dat” that converts the “train number” column of the “station time” table in the master data format into the “train number” column of the “train information” table in the “data format X”, and a data conversion program “prg00005.dat” that converts the “station name” column of the “station time” table in the master data format into the “station name” column of the “train information” table in the “data format X” are displayed as the reusable candidates.

As means for extracting the candidate of the reusable data conversion program, a method based on a known mechanical learning technology, such as use of a neural network, or a classifier such as a support vector machine, may be used in addition to the already described methods using the flows.

As contents and forms displayed in the conversion source column and the conversion destination column on the reusable candidate conversion component presentation screen 1110, the user interface unit 111 may set the display form of the appropriate column to a clickable highlighted display such as bold letters with an underlined portion. FIG. 17 illustrates a display example of this case.

The clickable highlighted display is applied to description regarding a column, the coincidence of which has been specified in the coincidence determination (step 3028 and 3029 and step 30210) between columns, and to which the similarity calculation weight value of the similarity calculation parameter table 102 has been applied.

In the example of FIG. 17, the user interface unit 111 of the data integration apparatus 100 sets letters of the column “train number” of the “station time” table in the master data format to the bold letters with an underlined portion, and sets letters of the column “train number” of the “train information” table in the “data format X” to the bold letters with an underlined portion.

In this case, the user interface unit 111 of the data integration apparatus 100 operates the input terminal 120 by the design developer and displays a pull-down menu 111031, for example, under the underlined portion in accordance with an event with the clicked underline portion. The pull-down menu 111031 is an interface that enables the design developer to change the similarity calculation weight value in the similarity calculation parameter table 102 used in the above coincident determination for the appropriate column. The example of FIG. 17 illustrates a menu that enables selection of the similarity calculation weight value applied to the “train number” column from among “3” to “1”.

The user interface unit 111 of the data integration apparatus 100 instructs the data structure similarity calculation unit 112 to calculate each similarity using the selected similarity calculation weight value in response to the selection of the similarity calculation weight value received from the design developer on the pull-down menu 111031.

Meanwhile, the data structure similarity calculation unit 112 re-executes each processing necessary for the similarity calculation (step 302) in response to the instruction. Further, the reusable data conversion component extraction unit 113, which has received a result of the re-execution, re-executes each processing necessary for the reusable data conversion program extraction processing (step 303) based on the similarity calculation result and the like.

The user interface unit 111 acquires a result of the re-execution, updates the screen 1110, and displays the result on the input terminal 120. Therefore, the above-described design developer can confirm the result of the change in the similarity calculation weight value.

Note that, in the above description, the pull-down menu 111031 has been described as an example of the user interface that accepts the change in the similarity calculation weight value. However, the present embodiment is not limited to the example and various existing interfaces (for example, a slider bar, a plurality of radio buttons, and the like) that accept a change instruction of a predetermined event may be appropriately adopted.

Although the best modes and the like for carrying out the present invention have been concretely described, the present invention is not limited thereto and various modifications can be made without departing from the gist of the invention.

According to the present embodiments, work of associating the data items between the data format requested by the distribution destination system or an application and the master data format is omitted, and the reusable component out of the already designed and developed data conversion processing components can be presented to the user of the data integration apparatus and the like.

That is, realization of efficient data conversion processing can be supported even between data with undefined conversion definition and the like.

At least the following matters will be clarified by the description of the present specification. That is, in the data integration apparatus of the present embodiment, the arithmetic unit may calculate the similarity by determining a coincidence of names and a coincidence of data types, of columns of target tables, and applying a result of the coincidence determination to a predetermined algorithm, in calculating the first and second similarities, and read, from the storage device, the conversion processing definition information on the specified predetermined table in the master data format and the specified predetermined table of the predetermined system regarding the columns with the coincidences specified in the coincidence determination, and output the conversion processing definition information to a predetermined device as the reusable conversion processing component candidate information, in outputting the reusable conversion processing component candidate information.

According to the data integration apparatus, the similarity can be efficiently calculated with favorable accuracy, and the reusable conversion processing component candidate information can be presented to a predetermined person in charge or the like, regarding an appropriate column between tables specified on the basis of the similarity. As a result, realization of accurate and more efficient data conversion processing can be supported even between data with undefined conversion definition and the like.

Further, in the data integration apparatus of the present embodiment, the arithmetic unit may calculate the similarity by the predetermined algorithm after applying a weighting value determined for each column according to magnitude of an influence on the similarity to the result of the coincidence determination, in calculating the similarities.

According to the data integration apparatus, the similarity can be efficiently calculated with more favorable accuracy, and the reusable conversion processing component candidate information can be presented to a predetermined person in charge or the like, regarding an appropriate column between tables specified on the basis of the similarity. As a result, realization of more accurate and efficient data conversion processing can be supported even between data with undefined conversion definition and the like.

Further, in the data integration apparatus of the present embodiment, the arithmetic unit may further output information regarding the columns with the coincidences specified in the coincidence determination and to which the weighting value has been applied, and a change interface for the weighting value applied in relation to the columns, for the specified predetermined table in the master data format and the specified predetermined table of the predetermined system, and re-execute the calculation of the similarities and each processing associated with the calculation in response to a weighting value change instruction received in the change interface, in outputting the reusable conversion processing component candidate information.

According to the data integration apparatus, change by a predetermined person in charge or the like is accepted regarding importance of a column affecting the similarity calculation, that is, the magnitude of the weighting value, whereby the similarity calculation can be possible with favorable accuracy according to knowledge of a highly skilled person in charge or the like. Further, information of re-specified tables on the basis of the similarity that may vary with the change of the weighting value and the usable conversion processing component candidate regarding an appropriate column between appropriate tables can be presented to a predetermined person in charge or the like. As a result, realization of more accurate, more efficient, and flexible data conversion processing can be supported even between data with undefined conversion definition and the like.

Further, in the data integration method of the present embodiment, the information processing apparatus may calculate the similarity by determining a coincidence of names and a coincidence of data types, of columns of target tables, and applying a result of the coincidence determination to a predetermined algorithm, in calculating the first and second similarities, and read, from the storage device, the conversion processing definition information on the specified predetermined table in the master data format and the specified predetermined table of the predetermined system regarding the columns with the coincidences specified in the coincidence determination, and output the conversion processing definition information to a predetermined device as the reusable conversion processing component candidate information, in outputting the reusable conversion processing component candidate information.

Further, in the data integration method of the present embodiment, the information processing apparatus may calculate the similarity by the predetermined algorithm after applying a weighting value determined for each column according to magnitude of an influence on the similarity to the result of the coincidence determination, in calculating the similarities.

Further, in the data integration method of the present embodiment, the information processing apparatus may further output information regarding the columns with the coincidences specified in the coincidence determination and to which the weighting value has been applied, and a change interface for the weighting value applied in relation to the columns, for the specified predetermined table in the master data format and the specified predetermined table of the predetermined system, and re-execute the calculation of the similarities and each processing associated with the calculation in response to a weighting value change instruction received in the change interface, in outputting the reusable conversion processing component candidate information.

### REFERENCE SIGNS LIST

100 data integration apparatus
101 data storage unit
102 similarity calculation parameter table
103 similarity calculation result temporary storage unit
104 data conversion processing component definition table
105 similarity calculation result storage unit
106 reusable component extraction result storage table
107 data structure definition table
108 data conversion component library
109 master data storage unit
110 distribution source data storage unit
111 user interface unit
112 data structure similarity calculation unit
113 reusable data conversion component extraction unit
114 communication unit
120 input terminal
130 distribution source system
131 data structure definition information
140 distribution destination system
150 dedicated line
201 CPU (arithmetic unit)
202 HDD (storage device)
203 memory
204 input device
205 display device
206 communication device
207 program

1. A data integration apparatus comprising:
a storage device configured to store information of a data format of each table used in a predetermined system in relation to data of a predetermined event and information of a master data format predetermined for each predetermined table as a universal data format among the data, and conversion processing definition information of data between the predetermined table in the master data format and a predetermined table in a predetermined data format of the predetermined system; and
an arithmetic unit configured to execute
processing of calculating a first similarity that is a similarity between a data format of a table regarding predetermined data, information of the data format of which has not been stored in the storage device, and the master data format of each predetermined table, and specifying a predetermined table in the master data format having the first similarity that satisfies a predetermined criterion,
processing of calculating a second similarity that is a similarity between the master data format of the specified predetermined table and the data format of each table of the system stored in the storage device, and specifying a predetermined table of a predetermined system having the second similarity that satisfies a predetermined criterion, and
processing of reading, from the storage device, the conversion processing definition information on the specified predetermined table in the master data format and the specified predetermined table of the predetermined system, and outputting the conversion processing definition information to a predetermined device as reusable conversion processing component candidate information.

2. The data integration apparatus according to claim 1, wherein
the arithmetic unit
calculates the similarity by determining a coincidence of names and a coincidence of data types, of columns of target tables, and applying a result of the coincidence determination to a predetermined algorithm, in calculating the first and second similarities, and
reads, from the storage device, the conversion processing definition information on the specified predetermined table in the master data format and the specified predetermined table of the predetermined system regarding the columns with the coincidences specified in the coincidence determination, and outputs the conversion processing definition information to a predetermined device as the reusable conversion processing component candidate information, in outputting the reusable conversion processing component candidate information.

3. The data integration apparatus according to claim 2, wherein the arithmetic unit
calculates the similarity by the predetermined algorithm after applying a weighting value determined for each column according to magnitude of an influence on the similarity to the result of the coincidence determination, in calculating the similarities.

4. The data integration apparatus according to claim 3, wherein the arithmetic unit
further outputs information regarding the columns with the coincidences specified in the coincidence determination and to which the weighting value has been applied, and a change interface for the weighting value applied in relation to the columns, for the specified predetermined table in the master data format and the specified predetermined table of the predetermined system, and re-executes the calculation of the similarities and each processing associated with the calculation in response to a weighting value change instruction received in the change interface, in outputting the reusable conversion processing component candidate information.

5. A data integration method in which an information processing apparatus including a storage device that stores information of a data format of each table used in a predetermined system in relation to data of a predetermined event and information of a master data format predetermined for each predetermined table as a universal data format among the data, and conversion processing definition information of data between the predetermined table in the master data format and a predetermined table in a predetermined data format of the predetermined system, executes:
processing of calculating a first similarity that is a similarity between a data format of a table regarding predetermined data, information of the data format of which has not been stored in the storage device, and the master data format of each predetermined table, and specifying a predetermined table in the master data format having the first similarity that satisfies a predetermined criterion,
processing of calculating a second similarity that is a similarity between the master data format of the specified predetermined table and the data format of each table of the system stored in the storage device, and specifying a predetermined table of a predetermined system having the second similarity that satisfies a predetermined criterion, and
processing of reading, from the storage device, the conversion processing definition information on the specified predetermined table in the master data format and the specified predetermined table of the predetermined system, and outputting the conversion processing definition information to a predetermined device as reusable conversion processing component candidate information.

6. The data integration method according to claim 5, wherein
the information processing apparatus
calculates the similarity by determining a coincidence of names and a coincidence of data types, of columns of target tables, and applying a result of the coincidence determination to a predetermined algorithm, in calculating the first and second similarities, and
reads, from the storage device, the conversion processing definition information on the specified predetermined table in the master data format and the specified predetermined table of the predetermined system regarding the columns with the coincidences specified in the coincidence determination, and outputs the conversion processing definition information to a predetermined device as the reusable conversion processing component candidate information, in outputting the reusable conversion processing component candidate information.

7. The data integration method according to claim 6, wherein the information processing apparatus
calculates the similarity by the predetermined algorithm after applying a weighting value determined for each column according to magnitude of an influence on the similarity to the result of the coincidence determination, in calculating the similarities.

8. The data integration method according to claim 7, wherein the information processing apparatus
further outputs information regarding the columns with the coincidences specified in the coincidence determination and to which the weighting value has been applied, and a change interface for the weighting value applied in relation to the columns, for the specified predetermined table in the master data format and the specified predetermined table of the predetermined system, and re-executes the calculation of the similarities and each processing associated with the calculation in response to a weighting value change instruction received in the change interface, in outputting the reusable conversion processing component candidate information.
